(19) United States
(12) Patent Application Publication
(10) Pub. No.: US 2025/0389524 A1
(43) Pub. Date: Dec. 25, 2025

(54) Tape Measure with Wide Tape Blade

(71) Applicant: Milwaukee Electric Tool Corporation, Brookfield, WI (US)

(72) Inventor: Thomas J. Schneider, Milwaukee, WI (US)

(21) Appl. No.: 19/247,711

(22) Filed: Jun. 24, 2025

Related U.S. Application Data
(60) Provisional application No. 63/663,338, filed on Jun. 24, 2024.

(51) Int. Cl. G01B 3/1003; G01B 3/1005; G01B 3/1041; G01B 3/1056

(52) U.S. Cl. CPC G01B 3/1003; G01B 3/1005; G01B 3/1041; G01B 3/1056; G01B 2003/103

(57) ABSTRACT

Various embodiments of a tape measure, including a tape measure blade having a cross-sectional profile to increase standout is provided. The profile has a curved shape that varies along the length of the tape blade. The curved shape increases standout. In one embodiment, the tape measure includes a hook and a magnetic assembly coupled to an outer end of the tape blade. A distance between an upper surface of the magnetic assembly and an upper surface of the hook is greater than a minimum distance.

### CROSS-REFERENCE TO RELATED PATENT APPLICATION

The present application claims the benefit of and priority to U.S. Provisional Application No. 63/663,338 filed on Jun. 24, 2024, which is incorporated herein by reference in its entirety.

### BACKGROUND OF THE INVENTION

The present invention relates generally to the field of tools. The present invention relates specifically to a tape measure, measuring tape, retractable rule, etc., that includes a tape measure blade with a profile shape that increases tape standout and a tape measure with a magnetic assembly having a low profile.

Tape measures are measurement tools used for a variety of measurement applications, including in the building and construction trades. Some tape measures include a graduated, marked blade wound on a reel and also include a retraction system for automatically retracting the blade onto the reel. In some such tape measure designs, the retraction system is driven by a coil or spiral spring that is tensioned, storing energy as the tape is extended, and that releases energy to spin the reel, winding the blade back onto the reel such that automatic or non-manual tape retraction is provided. In some other tape measure designs, retraction of the tape is controlled via a manual crank, and such tape measure blades tend to have a long length.

### SUMMARY OF THE INVENTION

One embodiment of the invention relates to a tape measure. The tape measure includes a housing, a tape reel rotatably mounted within the housing, and an elongate blade wound around the tape reel. The elongate blade includes an upper surface, a lower surface, a curved profile such that the upper surface of the elongate blade defines a concave surface and the lower surface defines a convex surface. The elongate blade further includes a flat width, a curved width, a first zone, a second zone, and a third zone. The curved width is less than the flat width. The first zone is located in a lengthwise portion of the elongate blade between an outer end of the elongate blade to 2 ft from the outer end of the elongate blade. The second zone is located in a lengthwise portion of the elongate blade at 2 ft to 12 ft from the outer end of the elongate blade. The third zone is located in a lengthwise portion of the elongate blade at 12 ft to 17 ft from the outer end of the elongate blade. The third zone has a first ratio of curved width to flat width between 0.68 and 0.73. The tape measure further includes a retraction system coupled to the tape reel, wherein the retraction system drives rewinding of the elongate blade on to the tape reel.

Another embodiment of the invention relates to a tape measure. The tape measure includes a housing, a reel rotatably mounted within the housing, and an elongate blade wound around the reel. The elongate blade includes opposing lateral edges, an upper concave surface, a lower convex surface, and a curved profile defined by the upper concave surface. The upper concave surface is positioned between the opposing lateral edges. The lower convex surface is positioned between opposing lateral edges. The elongate blade further includes a flat width, a curved width, a first zone, a second zone, and a third zone. The curved width is less than the flat width. The first zone is located in a lengthwise portion of the elongate blade extending from an outer end of the elongate blade. Third zone is located in a lengthwise portion of the elongate blade between the second zone and an inner end of the elongate blade, the inner end is coupled to the reel. The second zone is located in a lengthwise portion of the elongate blade between the first zone and the third zone. The first zone and the third zone each have a first ratio of curved width to flat width between 0.81 and 0.85. The tape measure further includes a retraction system coupled to the reel, wherein the retraction system drives rewinding of the elongate blade on to the reel.

Another embodiment of the invention relates to a tape measure. The tape measure includes a housing, a reel rotatably mounted within the housing, and an elongate blade wound around the reel. The elongate blade includes an upper surface, a lower surface, a curved profile such that the upper surface of the elongate blade defines a concave surface and the lower surface defines a convex surface. The elongate blade further includes a flat width, a curved width, a first zone, a second zone, and a third zone. The curved width is less than the flat width. The first zone is located in a lengthwise portion of the elongate blade extending from an outer end of the elongate blade. The third zone is located in a lengthwise portion of the elongate blade between the second zone and an inner end of the elongate blade. The inner end is coupled to the reel. The second zone is located in a lengthwise portion of the elongate blade between the first zone and the third zone. The first zone and the third zone each have a first ratio of curved width to flat width. The second zone has a second ratio of curved width to flat width. The second ratio of curved width to flat width is less than the first ratio of curved width to flat width. The second ratio of curved width to flat width is less than 0.73. The tape measure further includes a retraction system coupled to the reel, wherein the retraction system drives rewinding of the elongate blade on to the reel.

Additional features and advantages will be set forth in the detailed description which follows, and will be readily apparent to those skilled in the art from the description or recognized by practicing the embodiments as described in the written description and/or shown in the accompany drawings. It is to be understood that both the foregoing general description and the following detailed description are exemplary.

The accompanying drawings are included to provide further understanding and are incorporated in and constitute a part of this specification. The drawings illustrate one or more embodiments and, together with the description, serve to explain principles and operation of the various embodiments.

### BRIEF DESCRIPTION OF THE DRAWINGS

This application will become more fully understood from the following detailed description, taken in conjunction with the accompanying figures, wherein like reference numerals refer to like elements in which:

FIG. 1 is a left perspective view of a tape measure, according to an exemplary embodiment.

FIG. 2 is a perspective view of the tape measure of FIG. 1 with a portion of the tape blade extended from the housing, according to an exemplary embodiment.

FIG. 3 is a front perspective view of the tape measure of FIG. 1, according to an exemplary embodiment.

FIG. 4 is a side view of the tape measure of FIG. 1 with a portion of the housing removed, according to an exemplary embodiment.

FIG. 5 is a cross-sectional view of a coated tape blade of the tape measure of FIG. 1, according to an exemplary embodiment.

FIG. 6 is a schematic side view of the tape measure of FIG. 1 with a portion of the tape blade extended from the housing, according to an exemplary embodiment.

FIG. 7 is a cross-sectional view showing a profile of the tape blade, according to an exemplary embodiment.

FIG. 8 is a is a left perspective view of a tape measure, according to another exemplary embodiment.

FIG. 9 is a front perspective view of the tape measure of FIG. 8, according to an exemplary embodiment.

FIG. 10 is a perspective view of the tape measure of FIG. 8 with a portion of the tape blade extended and the housing removed, according to an exemplary embodiment.

FIG. 11 is a right-side view of the tape measure of FIG. 10, according to an exemplary embodiment.

FIG. 12 is a plan view of the magnet and hook of the tape measure of FIG. 8, according to an exemplary embodiment.

FIG. 13 is a plan view of the magnet of FIG. 12, according to an exemplary embodiment.

FIG. 14 is a perspective view of the magnet of FIG. 13, according to an exemplary embodiment.

FIG. 15 is a front perspective view of a tape measure, according to another exemplary embodiment.

FIG. 16 is a plan view of a magnet and housing of the tape measure of FIG. 15, according to an exemplary embodiment.

FIG. 17 is a top view of the magnet of FIG. 16, according to an exemplary embodiment.

FIG. 18 is a side view of the magnet of FIG. 16, according to an exemplary embodiment.

FIG. 19 is a plan view of a magnet and housing for a tape measure, according to another exemplary embodiment.

FIG. 20 is a top view of the magnet of FIG. 19 according to an exemplary embodiment.

FIG. 21 is a side view of the magnet of FIG. 19, according to an exemplary embodiment.

### DETAILED DESCRIPTION

Referring generally to the figures, various embodiments of a tape measure are shown. Various embodiments of the tape measure discussed herein include an innovative tape blade profile that Applicant believes greatly improves tape standout. In general, Applicant has determined that by shaping the tape blade to a relatively aggressive or steep curved profile shape (as discussed and quantified below), tape standout can be increased and tape droop can be decreased greatly even when utilizing relatively thin and/or relatively narrow pieces of steel for the tape blade. In some embodiments, the steep curved profile shape is formed only along a relatively short lengthwise section of the tape blade that is positioned within a lengthwise zone in which a standard tape tends to buckle during standout. Without being bound by a particular theory, Applicant understands that the steep curved profile shape increases rigidity and buckle resistance, and in particular, tape standout is greatly increased by locating this curved profile shape within the zone where buckling tends to occur. In some embodiments, the curved profile shape varies along the length of the tape blade. Without being bound by a particular theory, Applicant understands that the specific locations of the curved profile shape increases rigidity and buckle resistance, and in particular, tape standout in some lengthwise sections while decreasing droop and allowing for controlled speed of the tape blade within other lengthwise zones.

In some embodiments, the tape measure includes a hook and a magnetic assembly coupled to an outer end of the tape blade. In contrast to conventional magnetic assemblies that have sizes that may cause interference between the hook assembly and workpieces and/or objects, the magnetic assembly discussed herein has a low profile. Applicant believes the profile of the magnetic assembly allows for an increase in the amount of engagement between the hook assembly and the workpiece and/or object the user wants to engage with during use of tape measure. Additionally, Applicant believes the low profile of the magnetic assembly decreases rollover of the tape blade and therefore increases side standout of the tape blade.

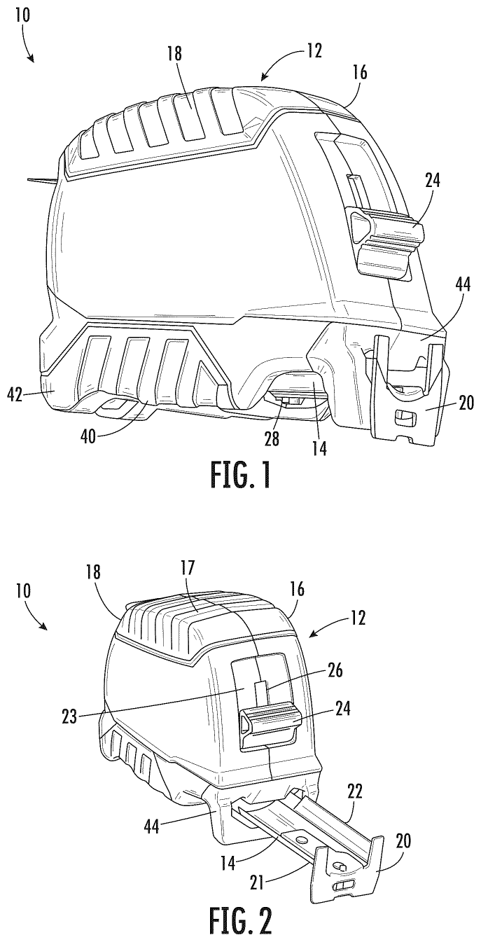

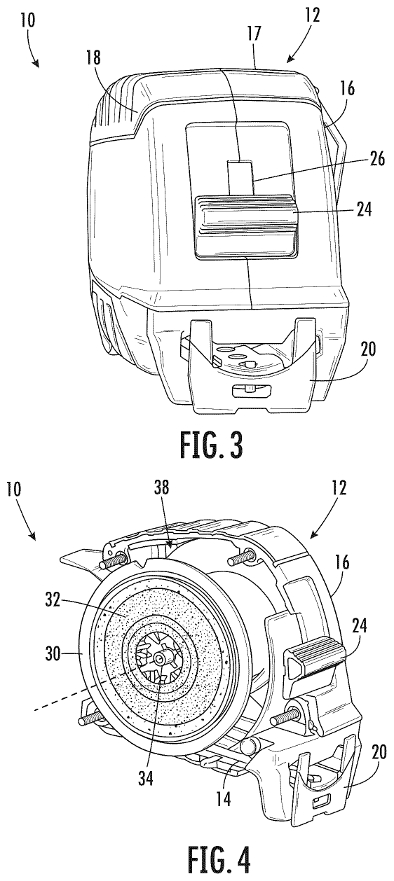

Referring to FIGS. 1-4, a length measurement device, such as tape measure 10, is shown according to an exemplary embodiment. Tape measure 10 includes a coilable tape blade 14 and a housing 12. In general, tape blade 14 is an elongate strip of material including a plurality of graduated measurement markings, and in specific embodiments, tape blade 14 is an elongate strip of metal material (e.g., steel material) that includes an outer most end coupled to a hook assembly, shown as hook assembly 20. In various embodiments, tape blade 14 may include various coatings (e.g., polymer coating layers) to help protect tape blade 14 from cracking during whip or pinch.

Further, tape blade 14 may include any combination of tape blade features of the various embodiments discussed herein. Specifically, in various embodiments, tape blade 14 includes a steep curved profile shape as discussed below that improves tape standout performance. As shown in FIG. 1, a variable-length extended segment 22 of the tape blade 14 is retractable and extendable from the housing 12. A hook assembly 20 is fixedly coupled to an outer end portion 21 of tape blade 14.

As shown in FIG. 4, the non-extended portion of tape blade 14 is wound onto a reel 30, which is surrounded by housing 12. Reel 30 is rotatably disposed about an axle 34 that defines an axis 36 of tape measure 10, and a retraction mechanism 32 is coupled to reel 30 and configured to drive reel 30 about rotation axis 36 which in turn provides powered retraction of tape blade 14. Retraction mechanism 32 may include one or more elongated spiral springs that provide the retraction energy to retraction mechanism 32. A tape lock 24 is provided to selectively engage tape blade 14, which acts to restrain retraction mechanism 32 such that extended segment 22 of tape blade 14 remains at a desired length.

Referring to FIG. 2, housing 12 includes a first side wall 16, a second side wall 18, and a peripheral wall 17 connecting first side wall 16 and second side wall 18. First side wall 16, second side wall 18, and peripheral wall 17 define an internal cavity 38, shown in FIG. 4, in which reel 30 and retraction mechanism 32 are housed. The side walls 16, 18 may be rectangular, polygonal, or any other desired shape. Portions of the housing 12 may be co-molded or separately formed of a resilient material, such as a natural or synthetic rubber. In the illustrated construction, housing 12 is formed with a support leg 42 which extends from a lower portion 40 of the peripheral wall 17.

A slot 26 is defined along a forward portion 23 of peripheral wall 17. Slot 26 provides an opening in the tape measure housing which allows tape lock 24 to extend into housing 12. In addition, slot 26 provides a length sufficient to allow tape lock 24 to be moved relative to housing 12 between locked and unlocked positions. Below the slot 26, a tape port 28 is provided in peripheral wall 17. Tape port 28 allows for the retraction and extension of tape blade 14 to and from the internal cavity 38 defined within housing 12.

As shown in FIGS. 1 and 2, tape measure 10 includes a finger guard 44. As shown in FIG. 1, when tape 14 is in the retracted position, a rear surface of hook assembly 20 abuts guard 44.

In various embodiments, tape blade 14 includes an upper coating layer 48 coupled to (e.g., attached, bonded, glued, etc.) the concave upper surface of inner metal layer 46 and a lower coating layer 50 coupled to (e.g., attached, bonded, glued, etc.) the convex lower surface of inner metal layer 46. In general, coating layers 48 and 50 are formed from a polymer material, and in a specific embodiment, are formed from a nylon material. In specific embodiments, coating layers 48 and 50 are formed from a material that has a modulus of elasticity less than the modulus of elasticity of the metal material of inner layer 46. In specific embodiments, coating layers 48 and 50 are formed from a polymer material. In various specific embodiments, coating layers 48 and 50 are formed from a polyethylene terephthalate (PET) film.

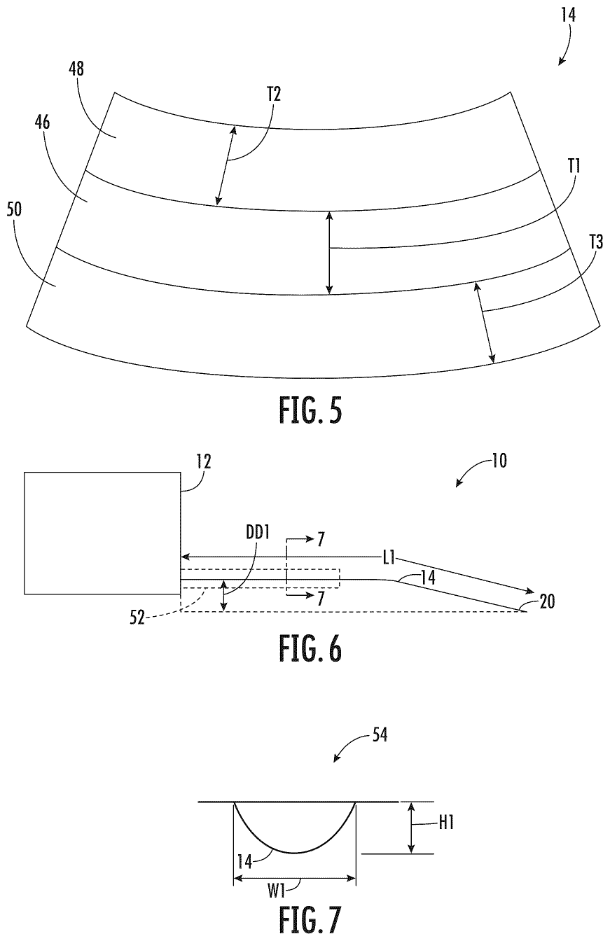

Tape blade 14 includes an elongate metal core 46 having an upper surface, a lower surface and a first thickness, T1, measured between the upper surface and the lower surface. In various embodiments, T1 is less than 0.15 mm and specifically less than 0.14 mm. In specific embodiments, T1 is about 0.13 mm (e.g., 0.13 mm plus or minus 0.005 mm). As shown in FIG. 5, coating layer 48 has a thickness, T2, and coating layer 50 has a thickness, T3. A total thickness of the tape blade coating is defined as the combined thickness of layers 48 and 50 (e.g., T2+T3). In one or more embodiments, the coating has a uniform thickness along an entire length of tape blade 14.

In various embodiments, tape blade 14 and the profile shapes discussed herein can be utilized to improve tape standout in tapes having a variety of lengths. In specific embodiments, the length of the tape blade is less than 50 feet or more specifically less than 40 feet. In various embodiments, the length of tape blade 14 is between 15 ft. and 40 ft., and in specific embodiments, the length of the tape blade is 35 ft., 30 ft., 25 ft., or 16 ft.

Referring to FIG. 6 and FIG. 7, tape blade 14 standout, droop and the cross-sectional profile shape parameters of the tape blade profile of the present disclosure are shown and described. In general, tape standout distance is the maximum length, L1, of tape blade 14 that can be extended from tape housing 12 when the tape housing 12 is positioned such that the tape blade exits the housing in a direction perpendicular to gravity while self-supporting its own weight without buckling and without additional support being provided other than what the tape measure housing itself provides (e.g., without the tape blade being supported by the user's hand). It should be noted that while tape blade standout can be measured using a variety other methods for other purposes (such field testing, marketing, etc.), tape standout distance, as used herein, is determined via the preceding test procedure.

In general, tape side standout distance is the maximum length, of tape blade 14 that can be extended from tape housing 12 when the tape housing 12 is positioned about 90 degrees relative to standout position (e.g., turned to the side) such that the tape blade exits the housing in a direction perpendicular to gravity while self-supporting its own weight without buckling and without additional support being provided other than what the tape. Droop distance, shown as DD1, is the vertical distance that the hook end 20 of tape blade 14 moves downward from the opening in tape housing, when a certain length of tape L1 is extended from tape housing 12 and while tape blade 14 is self-supporting. As shown in FIG. 6, L1 is the tape length extending from housing 12.

Referring to FIG. 7, the curvature profile 54 of tape blade 14 is shown according to an exemplary embodiment. In general, the curvature profiles, such as profile 54, discussed herein can be measured via a laser profilometer along the upper surface of coating layer 48. However, because in at least some embodiments, coating layer 48 is of a consistent thickness the profile of coating layer 48 discussed herein also generally reflects the shape of the steel core 46 of tape blade 14. In various embodiments, tape blade 14 has some curvature throughout an entire width of the tape blade. In such embodiments, the radius.

As discussed in detail herein, Applicant has found that a curvature profile 54 having one or more of the curvature shape features discussed and quantified below is effective at increasing standout and/or decreasing droop. While curvature profile 54 can be described and classified in a wide variety of ways, Applicant has determined that curved profile height, H1, curved profile width, W1, can be used to classify and quantify the profile shape parameters that improve standout performance. In addition, Applicant has determined that H, W, when evaluated in relation to flat tape blade width and steel thickness define relative parameters that quantify the standout improving profile shapes discussed herein. Various embodiments of curvature profile 54 and tape blade 14 are shown in Table 1 below.

In various embodiments, the flat width of tape blade 14 is greater than or equal to 33 mm such as greater than or equal to 33 mm and less than 40 mm, specifically greater than or equal to 33 mm and less than 38 mm, and more specifically greater than or equal to 34 mm and less than or equal to 36 mm. In a specific embodiment, the flat width of tape blade 14 is about 35 mm (e.g., 35 mm plus or minus 0.2 mm). The thickness of the metal inner core 46 (T1 discussed above) and of the coated tape blade 14 are as discussed above regarding FIG. 5.

W1, particularly when compared to the flat width of tape blade 14, provides an indication of the extent to which tape blade 14 is formed into a curved shape. In various embodiments, W1 is measured between opposing lateral edges of tape blade 14. Similarly, H1 particularly when compared to the flat width of tape blade 14, provides an indication of the extent to which tape blade 14 is formed into a curved shape.

Referring back to FIG. 6, in various embodiments, profile 54 is formed in a lengthwise subsection 53 of the total length of tape blade 14. In a specific embodiment, profile 54 is formed in the portion of tape blade 14 that tends to buckle during standout, and thus the increased rigidity provided by profile 54 in this region increases standout distance and/or decreases droop. Specifically, profile 54 is formed in a lengthwise sub-section 52 of tape blade 14 that is located adjacent to housing 12 when the amount of tape extended is approaching the maximum standout. Thus, while the positioning of profile 54 will vary somewhat depending on the standout length of a particular tape blade design, in general, lengthwise sub-section 52 extends from 12 feet to 17 feet from the hook end of tape blade 14.

In various embodiments, by forming tape blade 14 having profile 54 characterized via one or more of the profile dimensions discussed above, Applicant believes that significantly improved standout and droop decrease are achieved. In various embodiments, standout of tape blade 14 provided at least in part by profile 54 is greater than a minimum standout. In various embodiments, standout of tape blade 14 provided at least in part by profile 54 is greater than 185 inches, specifically greater than 189 inches, and more specifically greater than 194 inches. In one or more embodiments, the standout of tape blade 14 is about 189.6 inches. In one or more embodiments, the standout of tape blade 14 is about 195 inches.

In Table 1 below, tape design 1 represents a specific design having curved profiles that vary along the length of the tape blade. As such, in some embodiments, the steep curved profile shape is formed only along a relatively short lengthwise section of the tape blade that is positioned within a lengthwise zone in which a standard tape tends to buckle during standout. As can be seen from Table 1, the designs having the varying profiles along the length of the tape blade as discussed herein greatly increase standout and decreases droop while allowing for a smooth transition. In other words, the transition zone(s) allow for smooth or controlled speed of tape blade 14 without a large size for the tape measure which would be necessary due to the required torque.

In Table 1 below, tape design 2 represents a specific design having curved profiles that vary along the length of the tape blade. As such, in some embodiments, the steep curved profile shape is formed only along a relatively short lengthwise section of the tape blade that is positioned within a lengthwise zone in which a standard tape tends to buckle during standout. Similar to tape design 1, the profile of tape design 2 includes transition zone(s) to allow for smooth or controlled speed of tape blade 14 without necessitating a large size for the tape measure.

TABLE 1

| | Measurement Location | | | | | | | | | |
|---|---|---|---|---|---|---|---|---|---|---|
| | Zone 1 | | Zone 2 | | Zone 2 | | Zone 3 | | Zone 4 | |
| | measured at 1′ | | measured at 3′ | | measured at 8′ | | measured at 13′ | | measured at 20′ | |
| | | Ratio | | Ratio | | Ratio | | Ratio | | Ratio |
| | Curved | Curved | Curved | Curved | Curved | Curved | Curved | Curved | Curved | Curved |
| Tape | Width | width/flat | Width | width/flat | Width | width/flat | Width | width/flat | Width | width/flat |
| Design | (mm) | width | (mm) | width | (mm) | width | (mm) | width | (mm) | width |
| 1 | 29.1 | 0.831429 | 28.65 | 0.818571 | 26.5 | 0.7571429 | 24.75 | 0.7071429 | 29.1 | 0.8314286 |
| (35 mm) | (±0.75) | | (±1.0) | | (±1.0) | | (±0.75) | | (±0.75) | |
| 2 | 29.1 | 0.831429 | 28.65 | 0.818571 | 26.5 | 0.7571429 | 24.00 | 0.6857143 | 29.1 | 0.8314286 |
| (35 mm) | (±0.75) | | (±1.0) | | (±1.0) | | (±0.75) | | (±0.75) | |

As shown in Table 1, in various embodiments, tape blade 14 includes a plurality of zones having varied profiles. In various embodiments, the ratio of the curved width/flat width is met if there is any point on along the blade where the curve meets the ration. In various embodiments, the ratio of the curved width/flat width is the ratio of the average curved width along the length of the zone of the tape blade 14. In various specific embodiments, there are four profile zones. In various specific embodiments, there are five profile zones. In various specific embodiments, there are a different number of profiles zones (e.g., 3, 6, 7, etc.). In such embodiments, a first zone extends from outer end 21 of tape blade 14 along 2 feet of tape blade 14, a second zone extends from 2 feet to 12 feet, a third zone extends from 12 feet to 17 feet, a fourth zone extends from 17 feet to 19 feet from outer end 21, and a fifth zone extends from 19 feet to an inner end of tape blade 14. In various specific embodiments, the fourth zone has a curved width of 24.75 (±0.75) and a ratio of curved width to flat width between 0.686 and 0.729 when measured at 17 feet. In various specific embodiments, the fourth zone has a curved width of 29.1 (±0.75) and a ratio of curved width to flat width between 0.81 and 0.853 when measured at 19 feet.

In various specific embodiments, a first transition zone is defined from 2 feet to 12 feet along a length of tape blade 14. In various specific embodiments, a second transition zone is defined from 17 feet to 19 feet along a length of tape blade 14. In various specific embodiments, in various embodiments, tape blade 14 has a ratio of a curved width to a flat width between 0.69 and 0.84. In various embodiments, tape blade 14 has a curved width between 24 mm and 30 mm.

In various specific embodiments, the third zone has a ratio of curved width to flat width between 0.686 and 0.729. In specific embodiments, the third zone has a ratio of curved width to flat width between 0.68 and 0.73. In other words, in such embodiments, a third zone extends from 12 feet to 17 feet along a length of tape blade 14 from outer end 21 and has a ratio of curved width to flat width between 0.686 and 0.729. In various specific embodiments, the second zone has a ratio of the curved width to flat width between 0.729 and 0.847. In specific embodiments, specific embodiments, the second zone has a ratio of the curved width to flat width between 0.73 and 0.85. In other words, in such embodiments, the second zone extends from 2 feet to 12 feet along a length of tape blade 14 and has a ratio of curved width to flat width between 0.729 to 0.847. In a specific embodiment, the second zone includes a first portion extending between 2 feet and 12 feet and a second portion extending between 2 feet and 12 feet. The first portion of the second zone has a ratio of curved width to flat width different than the second portion of the second zone. In a specific embodiment, the first portion has a ratio of curved width to flat width between 0.79 and 0.847. In specific embodiments, the first portion has a ratio of curved width to flat width between 0.79 and 0.85. In a specific embodiment, the second portion of the second zone has a ratio of curved width to flat width between 0.729 and 0.786. In a specific embodiment, the second portion of the second zone has a ratio of curved width to flat width between 0.73 and 0.79.

In various specific embodiments, a first zone at a lengthwise portion of tape blade from outer end 21 to 2 ft and a third zone at a lengthwise portion of tape blade 14 from 19 ft to an inner end of tape blade have the same ratio of curved width to flat width. In a specific embodiment the ratio of curved width to flat width is between 0.81 and 0.853 for the first zone and the third zone. In such an embodiment a second zone is positioned at a lengthwise portion of tape blade 14 between the first zone and the third zone. In a specific embodiment, the second zone is positioned 12 feet to 17 feet from outer end 21 of tape blade 14.

In one or more embodiments, tape design 1 has the rigidity increasing profile discussed herein that greatly increases standout and decreases droop, particularly for a given flat width and/or steel thickness. In one or more embodiments, tape design 1 has a steel thickness less than a maximum steel thickness. In one or more embodiments, tape design 1 has a total thickness less than a maximum total thickness. In one or more embodiments, tape design 1 has a curved height greater than a minimum curved height. In one or more embodiments, tape design 1 has a standout distance of the elongate blade from the housing of greater than a minimum standout.

As shown in Table 1, tape design 2 is substantially the same as tape design 1 except for the differences discussed herein. In various specific embodiments, tape design 2 includes a tape blade 14 with a first zone at a lengthwise portion of tape blade from outer end 21 to 2 ft and a third zone at a lengthwise portion of tape blade 14 from 19 ft to an inner end of tape blade have the same ratio of curved width to flat width. In various specific embodiment, the third zone at a lengthwise portion of tape blade 14 from 19 ft to an inner end of tape blade has a curved width of 24.00 (±0.75) and a ratio of curved width to flat width between 0.664 and 0.707. As will be generally understood, in contrast to tape design 1, in zone 3 of tape design 2 provides improved standout.

In Table 2 below, in one or more embodiments, when tape designs 1-3 have the rigidity increasing profile discussed herein greatly increase standout and decrease droop, particularly for a given flat width and/or steel thickness. The data provided in table 2 includes the range of data from testing 30 samples of the tape design (i.e., flat width, thickness, etc.).

TABLE 2

| | Flat | Steel | Total | Curved | | |
|---|---|---|---|---|---|---|
| | Width | Thickness | Thickness | Height | Droop @ | |
| Tape Design | (mm) | (mm) | (mm) | (mm) | 10 ft (cm) | Standout (in) |
| 1 | 35 | 0.13 | 0.18 | 10.52888 | 93.2~98.4 | 167.7~172.5 |
| 2 | 35 | 0.13 | 0.18 | 10.85774 | 93.0~99.6 | 164.2~170.3 |
| 3 | 35 | 0.14 | 0.19 | 10.21986 | 94.3~103.6 | 94.3~103.6 |

In one or more embodiments, when tape design 1 has a retraction mechanism 32 that includes a spring, the spring must be sized to fit in a compact housing 12 while providing the necessary torque for the curved tape blade 14 profile(s). In one or more embodiments, tape design 1 has a spring having a spring width less than a maximum spring width. In one or more embodiments, tape design 1 has a spring having a spring length less than a maximum spring length. In one or more embodiments, tape design 1 has a spring having a spring thickness less than a maximum spring thickness.

In Table 3 below, in one or more embodiments, when tape measure 10 has a retraction mechanism 32 that includes a spring, the spring must be sized to fit in a compact housing 12 while providing the necessary torque for the curved tape blade 14 profile(s). Table 3 below includes an embodiment for the retraction system of a tape measure. In a specific embodiment, retraction system 1 is utilized with a tape blade having a 25 ft length.

TABLE 3

| Tape Design | Spring | Spring | Spring | | Surface | Core | Free Coil |
|---|---|---|---|---|---|---|---|
| Retraction | Width | Length | Thickness | | Hardness | Hardness | Diameter |
| System | (mm) | (mm) | (mm) | Material | (HV) | (HV) | (mm) |
| 1 (35 mm) | 34 | 2541.4 | 0.20 | SK85 | 590-640 | 570-620 | 23 |

In one or more embodiments, tape measure 10 and particularly tape blade 14 included an increased number of turns (e.g., number of times wound) to increase torque. In various specific embodiments, the number of turns were increased by 10. In one or more embodiments, a gear ratio was increased to achieve increased torque.

As shown in Table 3, in one or more embodiments, a spring utilized with tape measure 10 includes a spring having a length of about 2541.4 mm (e.g., 2541.4 mm plus or minus 254 mm). In one or more embodiments, the spring utilized with tape measure 10 has a spring with a spring width of about 34 mm (e.g., 34 mm plus or minus 0.01 mm). In one or more embodiments, the spring utilized with tape measure 10 has a spring with a spring thickness of about 0.20 mm (e.g., 0.20 mm plus or minus 0.005 mm).

In one or more specific embodiments, the spring utilized with tape measure 10 is formed from a metal material, such as a high carbon steel. In a specific embodiment, the spring is formed from SK85. In various embodiments, the spring has a surface hardness of 590 HV to 640 HV. In various embodiments, the spring has a core hardness of 570 HV to 620 HV. As will generally be understood, the surface hardness is taken at the surface. As will generally be understood the core hardness is measured at a center of the material. For example, if the material has a thickness of 0.13 mm then the core hardness is measure at 0.065 mm from the material surface. Applicant believes the hardness ranges of the tape designs discussed herein allow for a stiff tape blade that resists bending without being so stiff as to crack.

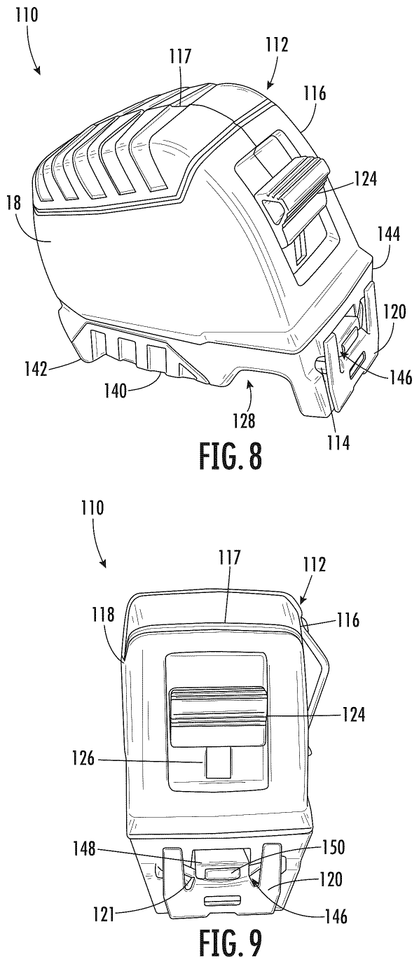

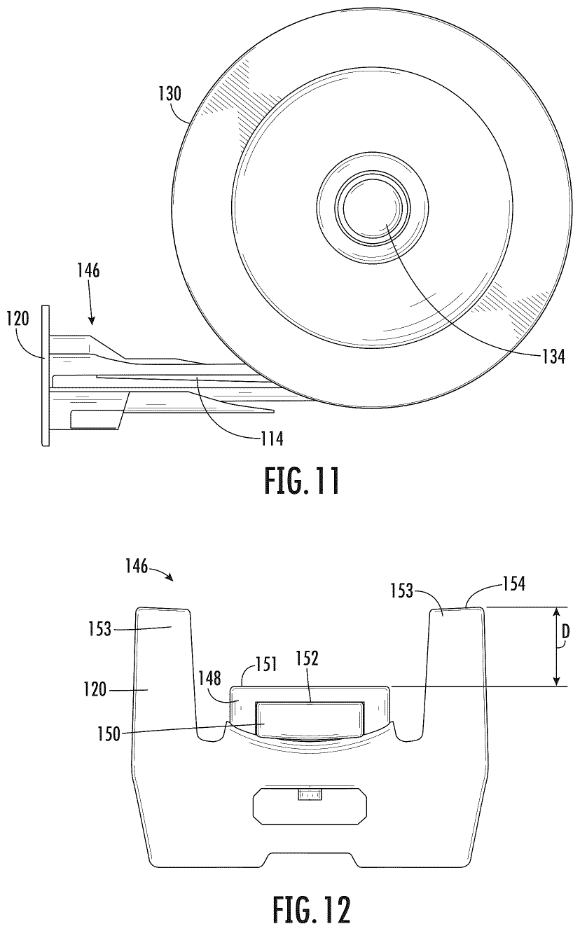

Referring to FIGS. 8-11, a length measurement device, such as tape measure 110, is shown according to another exemplary embodiment. Tape measure 110 is substantially the same as tape measure 10 except for the differences discussed herein. Tape measure 110 includes a magnetic assembly 146 on an outer end portion 121 of tape blade 114. As will be generally understood, use of magnetic assembly 146 on tape blade 114 allows for hook assembly 120 to easily attach to electrical metallic tubing (EMT), steel studs, and other metal objects or workpieces on a work site.

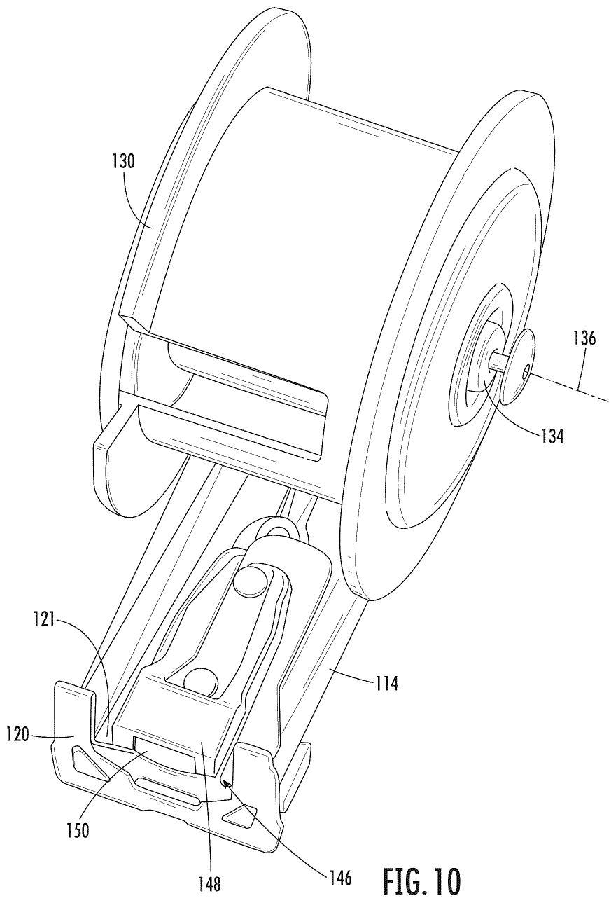

As shown in FIG. 10, magnetic assembly 146 includes a housing 148 and a magnet 150 at least partially positioned within housing 148. At least a portion of magnet 150 extends along outer end portion 121 of tape blade 114.

Referring to FIG. 12, a detailed view of hook assembly 120 and magnetic assembly 146 are shown according to an exemplary embodiment. Hook assembly 120 includes a pair of hook wings 153 positioned on opposing sides of magnetic assembly 146. Each hook wing 153 defines an upper surface 154. Hook assembly 120 and specifically hook wings 153 are configured to engage or grab an object and/or workpiece during use of tape measure 110. However, in contrast to conventional magnetic assemblies that have magnets with sizes that may interfere with the hook assembly engagement with objects, the magnetic assembly discussed herein has a low profile. Applicant believes the profile of magnet 150 allows for an increase in the amount of engagement between hook assembly 120 and the workpiece or object the user wants to engage with during the use of tape measure 110.

Magnet 150 includes an upper surface 152 (upward facing in the orientation shown in FIG. 12) and magnet housing 148 includes an upper surface 151 that is generally parallel to upper surface 152. Each hook wing 153 includes an upper surface 154. A distance D, defined between upper surface 154 of hook wing 153 and upper surface 151 of magnet housing 148 defines the amount of engagement or grab of hook assembly 120. In various embodiments, D is greater than a minimum distance. In various embodiments, D is greater than 3 mm, specifically greater than 3.5 mm, and more specifically greater than 3.9 mm. In various specific embodiments, D is about 4 mm.

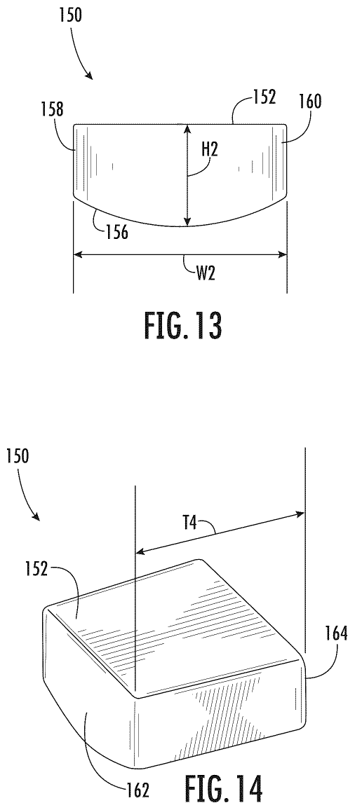

Referring to FIGS. 13-14, details of low profile magnet 150 are shown according to an exemplary embodiment. A height, H2, of magnet 150 is defined between upper surface 152 and an opposing lower surface 156 (downward facing in orientation shown in FIG. 13). Magnet 150 further includes a first side surface 158 and a second side surface 160. A width of magnet 150 is defined between first side surface 158 and second side surface 160.

As shown in FIG. 14, magnet 150 includes a front surface 162 and a rear surface 164. Front surface 162 and rear surface 164 extend between and connect first side surface 158 and second side surface 160. A thickness, T4, of magnet 150 is defined between front surface 162 and rear surface 164. A center of gravity of magnet 150 is located 3.215 mm in the vertical direction (i.e., y-direction) from a front top edge of magnet 150 (i.e., y-direction) and 3.25 mm into the page (i.e., z-direction, see FIG. 13).

Details regarding the low profile magnet 150 are shown according to an exemplary embodiment. In one or more embodiments, magnet design 1 has a magnet having a magnet height less than a maximum magnet height. In one or more embodiments, magnet design 1 has a magnet having a magnet width less than a maximum magnet width. In one or more embodiments, magnet design 1 has a magnet having a magnet thickness less than a maximum magnet thickness. In one or more embodiments, magnet design 1 has a magnet having a magnet with a ratio of height to width less than a maximum magnet ratio of height to width. In one or more embodiments, magnet design 1 has a magnet having a mass less than a maximum magnet mass.

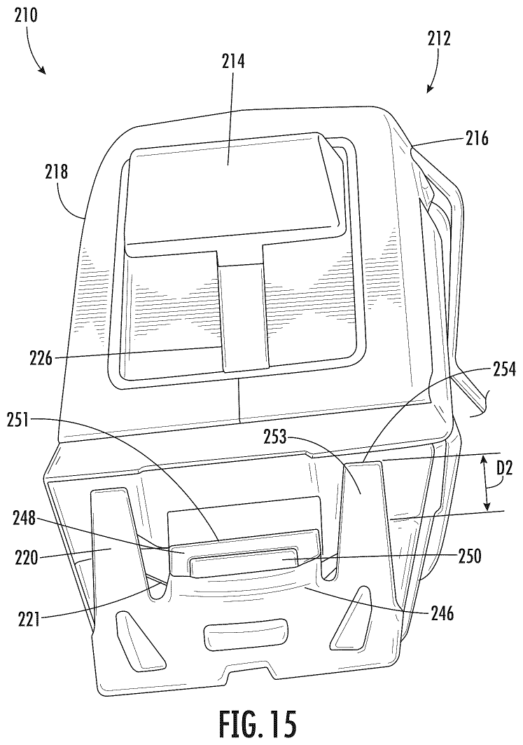

Referring to FIGS. 15-18, details of a tape measure 210 with a magnetic hook assembly 246 are shown according to an exemplary embodiment. Tape measure 210 is substantially the same as tape measure 10, 110 except for the differences discussed herein.

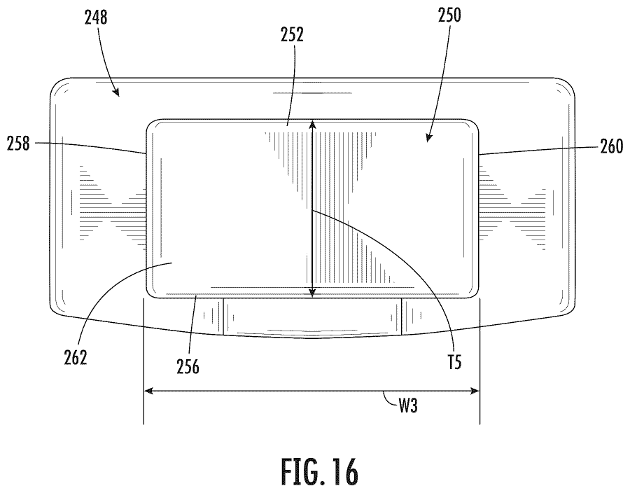

As shown in FIGS. 15-16, magnetic assembly 246 includes a housing 248 and a magnet 250 at least partially positioned within housing 248. At least a portion of magnet 250 extends along outer end portion 221 of tape blade 214. Hook assembly 220 includes a pair of hook wings 253 positioned on opposing sides of magnetic assembly 246. Each hook wing 253 defines an upper surface 254. Hook assembly 220 and specifically hook wings 253 are configured to engage or grab an object and/or workpiece during use of tape measure 210.

Magnet 250 includes an upper surface 252 (upward facing in the orientation shown in FIG. 16) and magnet housing 248 includes an upper surface 251 that is generally parallel to upper surface 252. Each hook wing 253 includes an upper surface 254. A distance D2, defined between upper surface 254 of hook wing 253 and upper surface 251 of magnet housing 248 defines the amount of engagement or grab of hook assembly 220. In various embodiments, D2 is greater than a minimum distance. In various embodiments, D2 is greater than 3 mm. In various embodiments, D2 is from 4 mm to 8 mm. In specific embodiments, D2 is about 8 mm. In specific embodiments, D2 is the same as D. In various specific embodiments, D2 is different than D.

Referring to FIGS. 16-18, details of magnet 250 are shown according to an exemplary embodiment. A thickness, T5, of magnet 250 is defined between upper surface 252 and an opposing lower surface 256 (downward facing in orientation shown in FIG. 16). Magnet 250 further includes a first side surface 258 and a second side surface 260. A front width, W3 of magnet 250 is defined between first side surface 258 and second side surface 260 along front surface 262.

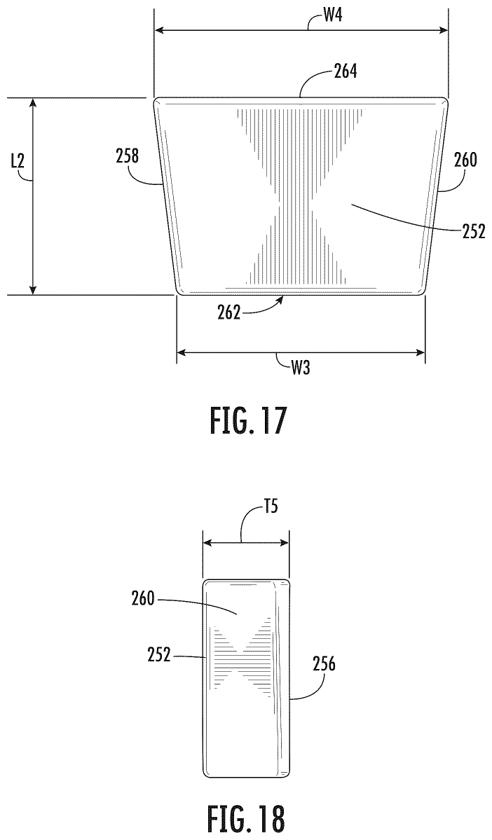

As shown in FIG. 17, the front surface 262 and a rear surface 264 of magnet 250 define different widths. Front surface 262 and rear surface 264 extend between and connect first side surface 258 and second side surface 260. A rear width, W4 of magnet 250 is defined between first side surface 258 and second side surface 260 along rear surface 264. A length, L2, of magnet 250 is defined between front surface 262 and rear surface 264. As shown in row 1 of table 4 below, in various embodiments, W3 is less than W4. In various embodiments, magnet 250 is formed from neodymium. In specific embodiments, magnet 250 is formed from N55.

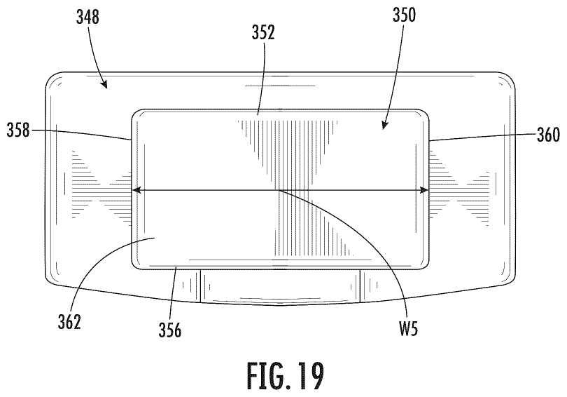

As shown in FIGS. 19-21, details of a magnetic assembly 346 that can be utilized with a tape measure such as tape measure 210 are shown according to an exemplary embodiment. Magnetic assembly 346 includes a housing 348 and a magnet 350 at least partially positioned within housing 348.

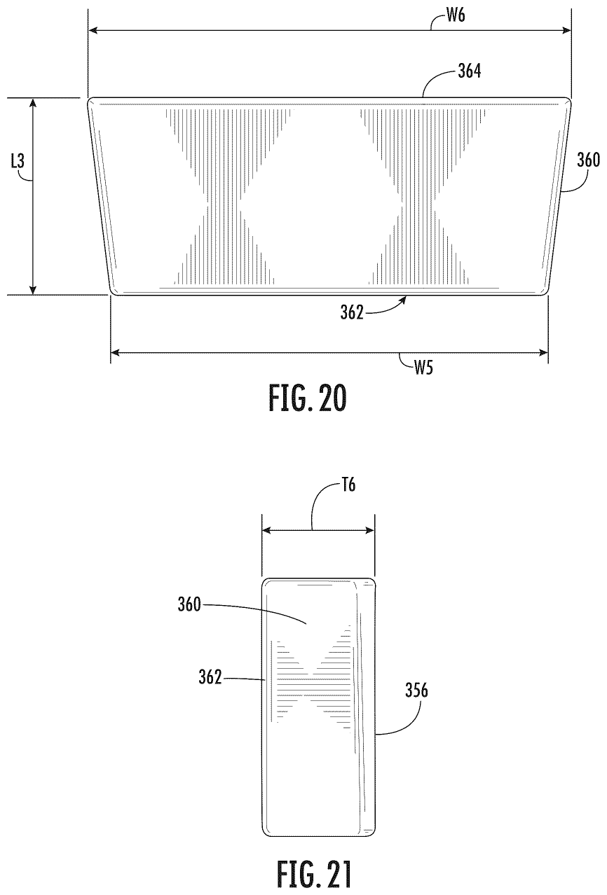

Referring to FIGS. 20-21, details of magnet 350 are shown according to another exemplary embodiment. A thickness, T6, of magnet 350 is defined between upper surface 352 and an opposing lower surface 356 (downward facing in orientation shown in FIG. 19). Magnet 350 further includes a first side surface 358 and a second side surface 360. A front width, W5 of magnet 350 is defined between first side surface 358 and second side surface 360 along front surface 362.

As shown in FIG. 20, the front surface 362 and a rear surface 364 of magnet 350 define different widths. Front surface 362 and rear surface 364 extend between and connect first side surface 358 and second side surface 360. A rear width, W6 of magnet 350 is defined between first side surface 358 and second side surface 360 along rear surface 364. A length, L3, of magnet 350 is defined between front surface 362 and rear surface 364. As shown in row 2 of table 4 below, in various embodiments, W5 is less than W6. In various embodiments, magnet 350 is formed from neodymium. In specific embodiments, magnet 350 is formed from N55.

In Table 4 below, details regarding magnets 150, 250, 350 and various other magnet designs are shown according to exemplary embodiments. As will be generally understood, the different grades of Neodymium provide different forces, that is, the higher the grade, the higher the force.

TABLE 4

| | | Magnet | Magnet | | |
|---|---|---|---|---|---|
| | Magnet | Length | Thickness | Mass | |
| Magnet Design | Width(mm) | (mm) | (mm) | (g) | Grade |
| 1 | Front: 10 | 8 | 3.5 | ~2 | N55 |
| | Back: 11.85 | | | | |
| 2 | Front: 13.54 | 6 | 2.7 | ~2 | N55 |
| | Back: 11.85 | | | | |
| 3 | Front: 10 | 8 | 3.5 | ~2 | N58 |
| | Back: 11.85 | | | | |
| 4 | Front: 10 | 8 | 5 | ~3 | N45 |
| | Back: 11.85 | | | | |
| 5 | Front: 10 | 8 | 5 | ~3 | N52 |
| | Back: 11.85 | | | | |

It should be understood that the figures illustrate the exemplary embodiments in detail, and it should be understood that the present application is not limited to the details or methodology set forth in the description or illustrated in the figures. It should also be understood that the terminology is for the purpose of description only and should not be regarded as limiting.

Further modifications and alternative embodiments of various aspects of the disclosure will be apparent to those skilled in the art in view of this description. Accordingly, this description is to be construed as illustrative only. The construction and arrangements, shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present disclosure.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more component or element, and is not intended to be construed as meaning only one.

For purposes of this disclosure, the term “coupled” means the joining of two components directly or indirectly to one another. Such joining may be stationary in nature or movable in nature. Such joining may be achieved with the two members and any additional intermediate members being integrally formed as a single unitary body with one another or with the two members or the two members and any additional member being attached to one another. Such joining may be permanent in nature or alternatively may be removable or releasable in nature. As used herein, “rigidly coupled” refers to two components being coupled in a manner such that the components move together in a fixed positional relationship when acted upon by a force.

While the current application recites particular combinations of features in the claims appended hereto, various embodiments of the invention relate to any combination of any of the features described herein whether or not such combination is currently claimed, and any such combination of features may be claimed in this or future applications. Any of the features, elements, or components of any of the exemplary embodiments discussed above may be used alone or in combination with any of the features, elements, or components of any of the other embodiments discussed above.

In various exemplary embodiments, the relative dimensions, including angles, lengths and radii, as shown in the Figures are to scale. Actual measurements of the Figures will disclose relative dimensions, angles and proportions of the various exemplary embodiments. Various exemplary embodiments extend to various ranges around the absolute and relative dimensions, angles and proportions that may be determined from the Figures. Various exemplary embodiments include any combination of one or more relative dimensions or angles that may be determined from the Figures. Further, actual dimensions not expressly set out in this description can be determined by using the ratios of dimensions measured in the Figures in combination with the express dimensions set out in this description.

What is claimed is:

1. A tape measure comprising:
a housing;
a tape reel rotatably mounted within the housing;
an elongate blade would around the tape reel, the elongate blade comprising:
an upper surface;
a lower surface;
a curved profile such that the upper surface of the elongate blade defines a concave surface and the lower surface defines a convex surface;
a flat width;
a curved width, wherein the curved width is less than the flat width;
a first zone located in a lengthwise portion of the elongate blade between an outer end of the elongate blade to 2 ft from the outer end of the elongate blade;
a second zone located in a lengthwise portion of the elongate blade at 2 ft to 12 ft from the outer end of the elongate blade; and
a third zone located in a lengthwise portion of the elongate blade at 12 ft to 17 ft from the outer end of the elongate blade;
wherein the third zone has a first ratio of curved width to flat width between 0.68 and 0.73; and
a retraction system coupled to the tape reel, wherein the retraction system drives rewinding of the elongate blade on to the tape reel.

2. The tape measure of claim 1, wherein the elongate blade further comprises a fourth zone located in a lengthwise portion of the elongate blade at 17 ft to 19 ft from the outer end of the elongate blade.

3. The tape measure of claim 2, wherein the elongate blade further comprises a fourth zone located in a lengthwise portion of the elongate blade at 19 feet from the outer end of the elongate blade to an inner end of the elongate blade, wherein the inner end is coupled to the tape reel.

4. The tape measure of claim 1, wherein the first zone has a second ratio of curved width to flat width, wherein the second zone has a third ratio of curved width to flat width, and wherein the second ratio of curved width to flat width and the third ratio of curved width to flat width are different than the first ratio of curved width to flat width.

5. The tape measure of claim 4, wherein the third ratio of curved width to flat width is between 0.73 and 0.85.

6. The tape measure of claim 1, wherein a thickness of the elongate blade is defined between the upper surface and the lower surface, wherein the thickness is about 0.13 mm.

7. The tape measure of claim 1, further comprising an upper coating layer coupled to the upper surface of the elongate blade and a lower coating layer coupled to the lower surface of the elongate blade, wherein the upper coating layer and the lower coating layer are formed from a polymer material.

8. The tape measure of claim 1, wherein the flat width is less than 36 mm.

9. The tape measure of claim 1, further comprising a hook assembly coupled to the outer end of the elongate blade, the hook assembly comprising:
a housing;
a magnet positioned within the housing and along the outer end of the elongate blade; and
a pair of opposing hook wings, wherein the magnet is positioned between the pair of opposing hook wings.

10. A tape measure comprising:
a housing;
a reel rotatably mounted within the housing;
an elongate blade would around the reel, the elongate blade comprising:
opposing lateral edges;
an upper concave surface positioned between the opposing lateral edges;
a lower convex surface positioned between the opposing lateral edges;
a curved profile defined by the upper concave surface;
a flat width;
a curved width, wherein the curved width is less than the flat width;
a first zone located in a lengthwise portion of the elongate blade extending from an outer end of the elongate blade;
a second zone; and
a third zone located in a lengthwise portion of the elongate blade between the second zone and an inner end of elongate blade, wherein the inner end is coupled to the reel;
wherein the second zone is located in a lengthwise portion of the elongate blade between the first zone and the third zone;
wherein the first zone and the third zone each comprise a first ratio of curved width to flat width between 0.81 and 0.85; and
a retraction system coupled to the reel, wherein the retraction system drives rewinding of the elongate blade on to the reel.

11. The tape measure of claim 10, wherein the tape blade has a flat width of 35 mm, and wherein the second zone is located in a lengthwise portion of the elongate blade at 12 ft to 17 ft from the outer end of the elongate blade.

12. The tape measure of claim 11, wherein the second zone comprises a second ratio of curved width to flat width, and wherein the second ratio of curved width to flat width is between 0.68 and 0.73.

13. The tape measure of claim 10, further comprising a fourth zone located in a lengthwise portion of the elongate blade between the first zone and the second zone, wherein the fourth zone comprises a second ratio of curved width to flat width, and wherein the second ratio of curved width to flat width is between 0.73 and 0.85.

14. The tape measure of claim 10, wherein the curved profile of the elongate blade has a curvature throughout an entire width of the elongate blade.

15. The tape measure of claim 14, wherein a radius of curvature of the elongate blade increases from a center of the elongate blade to one of the opposing lateral edges of the elongate blade.

16. A tape measure comprising:
a housing;
a reel rotatably mounted within the housing;
an elongate blade would around the reel, the elongate blade comprising:
an upper surface;
a lower surface;
a curved profile such that the upper surface of the elongate blade defines a concave surface and the lower surface defines a convex surface;
a flat width;
a curved width, wherein the curved width is less than the flat width;
a first zone located in a lengthwise portion of the elongate blade extending from an outer end of the elongate blade;
a second zone; and
a third zone located in a lengthwise portion of the elongate blade between the second zone and an inner end of elongate blade, wherein the inner end is coupled to the reel;
wherein the second zone is located in a lengthwise portion of the elongate blade between the first zone and the third zone;
wherein the first zone and the third zone each comprise a first ratio of curved width to flat width, wherein the second zone comprises a second ratio of curved width to flat width, wherein the second ratio of curved width to flat width is less than the first ratio of curved width to flat width, and wherein the second ratio of curved width to flat width is less than 0.73; and
a retraction system coupled to the reel, wherein the retraction system drives rewinding of the elongate blade on to the reel.

17. The tape measure of claim 16, wherein the second zone is located in a lengthwise portion of the elongate blade at 12 ft to 17 ft from the outer end of the elongate blade.

18. The tape measure of claim 16, wherein a curved width of the second zone is between 24 mm and 25.5 mm.

19. The tape measure of claim 16, wherein the first zone is located in a lengthwise portion of the elongate blade between the outer end of the elongate blade and 2 ft from the outer end, and wherein the third zone is located in a lengthwise portion of the elongate blade at 19 ft from the outer end of the elongate blade to the inner end of the elongate blade.

20. The tape measure of claim 16, wherein a curved width of the first zone and the third zone is between 28.35 mm and 29.85 mm.
